(19) United States
(12) Patent Application Publication
(10) Pub. No.: US 2020/0027234 A1
(43) Pub. Date: Jan. 23, 2020

(54) LOCATION INFORMATION IDENTIFYING METHOD, LOCATION INFORMATION IDENTIFYING DEVICE, AND LOCATION INFORMATION IDENTIFYING PROGRAM

(71) Applicant: Hajime KASAHARA, Kanagawa (JP)

(72) Inventor: Hajime KASAHARA, Kanagawa (JP)

(21) Appl. No.: 16/337,991

(22) PCT Filed: Sep. 28, 2017
(86) PCT No.: PCT/JP2017/035086

§ 371 Date: Mar. 29, 2019

(30) Foreign Application Priority Data
Oct. 2, 2016 (JP) 2016-195320

(51) Int. Cl. G06T 7/70; G06T 7/00; G01C 3/08

(52) U.S. Cl. CPC G06T 7/70; G06T 2207/30252; G01C 3/08; G06T 7/97

(57) ABSTRACT

[Problem]

To provide a location information identifying method for accurately specifying a position and the like of an object shown in an image.

[Solution]

A location information identifying method includes; a step for obtaining the object image 3 photographed by the drive recorder 2; a step for obtaining the first scale plate image 42 obtained when the first scale plate 4 arranged so as to be opposed to the drive recorder 2 at the first distance X apart from the drive recorder 2 is photographed; a step for overlapping the first scale plate image 42 and the object image 3 with each other; a step for measuring the image-height A, which is the distance from the object 5 located at the preset height H1 to the center of the object image 3, appeared on the object image 3, by using the first scale plate image 42; a step for calculating the angle B between the horizontal plane and the straight line joining the drive recorder 2 to the object 5, by using image-height A and the first distance X; and a step for calculating the target distance Y1 from the drive recorder 2 to the object 5, based on the height difference H between the drive recorder 2 and the object 5 and the angle B as well.

### TECHNICAL FIELD of THE INVENTION

The present invention relates to a position-information specifying method, a position-information specifying device, and a position-information specifying program for accurately specifying a position and the like of an object shown in an image.

### PRIOR ART

Conventionally, when a traffic accident is occurred by a vehicle in which a drive recorder is set up, the velocity of the vehicle at the moment of the accident is specified as below.

For example, it is assumed that the traffic accident takes place immediately after the vehicle has passed over a crosswalk. First, two momentary image frames; one is an image at the moment when the head of the vehicle has reached the crosswalk, and the other is an image at the moment when the head of the vehicle has passed over the crosswalk, are selected by eye. Then, the velocity of the vehicle is specified by dividing the length of the crosswalk by the time difference between these two image frames.

### SUMMARY OF INVENTION

### Problem to Be Solved By the Invention

In most cases, however, the accident spot is apart from the drive recorder by 10 m or more, while the drive recorder is mounted in the vehicle at the position of 110 to 130 cm high from the ground. Considering the above, 1 mm on the image can actually correspond to dozens of centimeters to several meters.

Accordingly, even if the moment when the head of the vehicle has reached the crosswalk is determined by eye, the moment can be widely different from the real accident moment. Therefore, the velocity of the vehicle calculated in the above way cannot be accurate, and the blame percentage in the accident would also be calculated incorrectly.

Due to the characteristics of the camera and the lens, the image photographed by the drive recorder is distorted in accordance with deviation from the center of the image. Considering the fact, the positional error of the vehicle calculated by the above way would be larger, according to the deviation.

Moreover, in most cases, a vehicle is decelerated by the brake, immediately before the accident. However, in the above way, only the average velocity of the moment when the head of the vehicle has reached the crosswalk and the moment when the head of the vehicle has passed over the crosswalk is specified. Thus, the velocity at the crush moment is not specified.

In view of the foregoing, it is an object of the invention to provide a position-information specifying method, a position-information specifying device, and a position-information specifying program for accurately specifying a position and the like of an object shown in an image.

### Means for Solving the Problem

The present invention provides a position-information specifying method includes: a step for obtaining an object image photographed by a first photographing means having a predetermined distortion characteristic, a predetermined distortion being caused on the object image due to the predetermined distortion characteristic; a step for obtaining a first scale plate image corresponding to an image obtained when a first scale plate, which has a first scale and is arranged so as to be opposed to a second photographing means having the predetermined distortion characteristic at a first distance, is photographed by the second photographing means; a step for overlapping the first scale plate image and the object image with each other; a step for measuring an image-height between an object, which is appeared on the object image and located at a preset height, and a center of the object image, by using the first scale of the first scale plate image; a step for calculating an angle between a horizontal plane and a straight line joining the first photographing means to the object, based on the image-height and the first distance; and a step for calculating at least one of a target distance and a horizontal distance between the first photographing means and the object, based on the angle and a height difference between the first photographing means and the object.

In this configuration, the image-height of the object whose distortion is corrected can be obtained, by using the first scale plate image corresponding to the distortion characteristic. The distortion-corrected angle between the horizontal plane and the straight line joining the first photographing means to the object is calculated by using the distortion-corrected image-height and the first distance. Therefore, distortion-corrected value of the target distance or the horizontal distance between the first photographing means and the object can be accurately calculated, based on the height difference between the preset height of the first photographing means and the preset height of the object and the distortion-corrected angle as well.

Further, it is preferable that the position-information specifying method further includes a step for calculating two target distances or two horizontal distances between the first photographing means and the object, with respect to two object images photographed at a predetermined time span; and also calculating a relative velocity between the first photographing means and the object by dividing a difference between the two first target distances or the two horizontal distance, by the predetermined time span.

With this configuration, the instantaneous relative velocity between the first photographing means and the object can be accurately calculated.

It is preferable that the position-information specifying method further includes: a step for arranging a second scale plate having a second scale so as to be opposed to the first scale plate at a second distance apart from the first scale plate; a step for obtaining a second scale plate image which is obtained when the first scale plate and the second scale plate are photographed by the second photographing means; and a step for calculating the first distance, based on the first scale on the second scale plate image, the second scale on the second scale plate image, and the second distance.

With this configuration, the first distance is calculated after the first scale plate is arranged in an arbitrary position, considering the possibility that the first scale plate cannot be arranged properly at the designated place. In this way, even when the windshield would be a hindrance, the first distance can be accurately calculated. As the result, the target distance can also be accurately calculated.

Another aspect of the present invention provides a position-information specifying device includes:

an obtaining unit configured to obtain an object image photographed by a first photographing means having a predetermined distortion characteristic, a predetermined distortion being caused on the object image due to the predetermined distortion characteristic; a storing unit configured to store a first scale plate image corresponding to an image obtained when a first scale plate, which has a first scale and is arranged so as to be opposed to a second photographing means having the predetermined distortion characteristic at a first distance, is photographed by the second photographing means, and object information of an object which should be located at a preset height; an overlapping unit configured to overlap the first scale plate image and the object image with each other; a specifying unit configured to specify the object appeared on the object image while referring to the object information; a measuring unit configured to measure an image-height between the object, which is appeared on the object image and located at the preset height, and a center of the object image, by using the first scale of the first scale plate image; and a calculating unit configured to calculate an angle between a horizontal plane and a straight line joining the first photographing means to the object, based on the image-height and the first distance; and calculate at least one of a target distance and a horizontal distance between the first photographing means and the object, based on the angle and a height difference between the first photographing means and the object.

Further, it is preferable that the calculating unit calculates two target distances or two horizontal distances between the first photographing means and the object, with respect to two object images photographed at a predetermined time span; and also calculating a relative velocity between the first photographing means and the object by dividing a difference between the two first target distances or the two horizontal distance, by the predetermined time span.

Another aspect of the present invention provides a position-information specifying program installed on a computer storing an object image photographed by a first photographing means having a predetermined distortion characteristic, a predetermined distortion being caused on the object image due to the predetermined distortion characteristic; a first scale plate image corresponding to an image obtained when a first scale plate, which has a first scale and is arranged so as to be opposed to a second photographing means having the predetermined distortion characteristic at a first distance, is photographed by the second photographing means; and object information of an object which should be located at a preset height. The program includes: a step for overlapping the first scale plate image and the object image with each other; a step for specifying the object appeared on the object image while referring to the object information; a step for measuring an image-height between the object, which is appeared on the object image and located at the preset height, and a center of the object image, by using the first scale of the first scale plate image; and a step for calculating the angle between a horizontal plane and a straight line joining the first photographing means to the object, based on the image-height and the first distance, and calculating at least one of a target distance and a horizontal distance between the first photographing means and the object, based on the angle and a height difference between the first photographing means and the object.

Further, It is preferable that the calculating step also calculates two target distances or two horizontal distances between the first photographing means and the object, with respect to two object images photographed at a predetermined time span; and also calculating a relative velocity between the first photographing means and the object by dividing a difference between the two first target distances or the two horizontal distance, by the predetermined time span.

### Effects of the Invention

According to the position-information specifying method, the position-information specifying device, and the position-information specifying program, it becomes possible to accurately specify position and the like of an object shown in an image.

### BRIEF DESCRIPTION OF THE DRAWINGS

FIG. 1 is a flowchart of a position-information specifying method according to a first embodiment of the present invention.

FIG. 2 is an explanatory drawing of an object image according to the first embodiment of the present invention.

FIG. 3 is an explanatory drawing of calculation of a target distance according to the first embodiment of the present invention.

FIG. 4(a) is a plan view of a first scale plate according to the first embodiment of the present invention.

FIG. 4(b) is a plan view of a first scale plate image according to the first embodiment of the present invention.

FIG. 5 is an explanatory drawing of overlapping the first scale plate image and the object image with each other, according to the first embodiment of the present invention.

FIG. 6 is a flowchart of a way to calculate a first distance, according to a second embodiment of the present invention.

FIG. 7 is an explanatory drawing of calculation of the first distance, according to the second embodiment of the present invention.

FIG. 8 is a plan view of a second scale plate image according to the second embodiment of the present invention.

FIG. 9 is a block diagram of a position-information specifying device according to a third embodiment of the present invention.

FIG. 10 is a flowchart of the operation of a control unit according to the third embodiment of the present invention.

### PREFERRED EMBODIMENTS

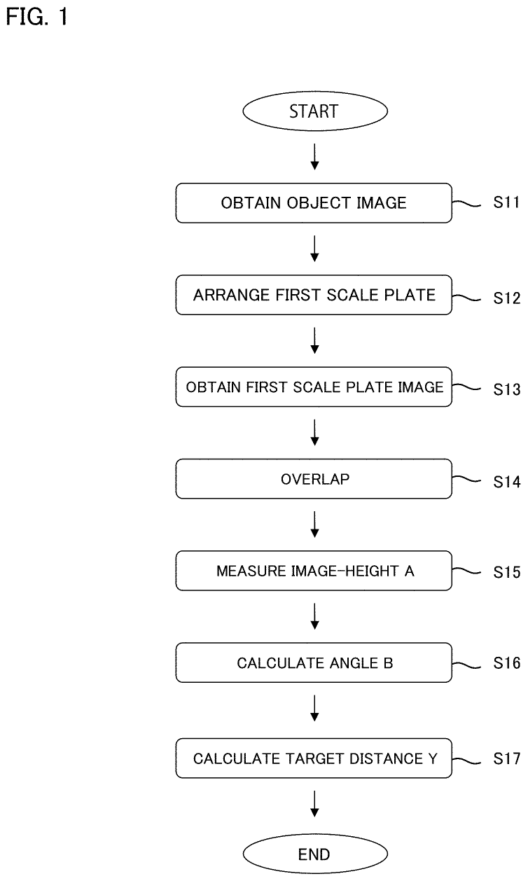

A position-information specifying method according to a first embodiment of the present invention will be described below while referring to FIG. 1 to FIG. 5.

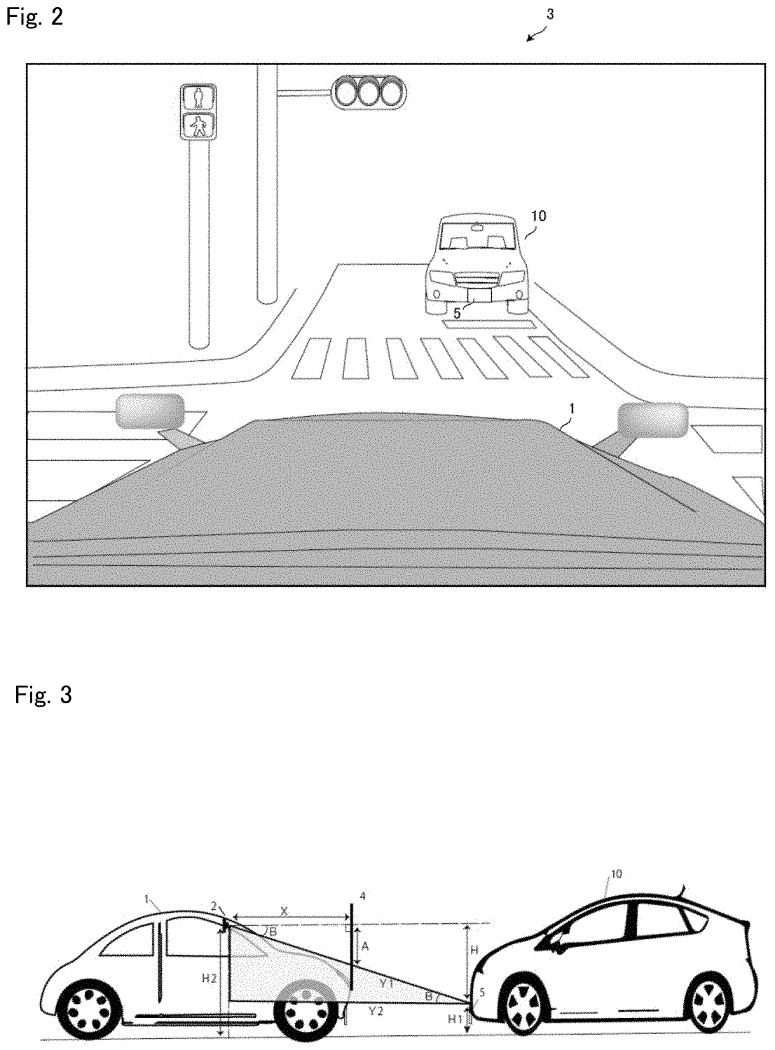

In this embodiment, based on the object image 3 photographed by drive recorder 2 (the first photographing means and the second photographing means in the present invention (refer to FIG. 2)) mounted on the vehicle 1, the position and velocity of the oncoming vehicle 10 at the moment of photographing, which is appeared in the object image 3, are specified.

As illustrated in FIG. 3, on the oncoming vehicle 10, the license plate 5 (“object” in the present invention) is attached at the position of preset height H1 above the ground.

The drive recorder 2 has a predetermined distortion characteristic. In this embodiment, the distortion is assumed to be larger in accordance with the deviation from the center of the image. Further, as illustrated in FIG. 3, drive recorder 2 is mounted at the position of preset height H2 above the ground.

Hereinafter, a method (position-information specifying method) for measuring the position and the velocity of the oncoming vehicle 10 according to this embodiment is described, while referring to the flowchart of FIG. 1.

First, an object image 3 (FIG. 2 in this embodiment) photographed by the drive recorder 2 is obtained (S11).

In this embodiment, an image frame making up a video image photographed by the drive recorder 2 is obtained as the object images 3.

Next, as shown in FIG. 3, a first scale plate 4 is arranged so as to be opposed to the drive recorder 2 at a first distance X (S12).

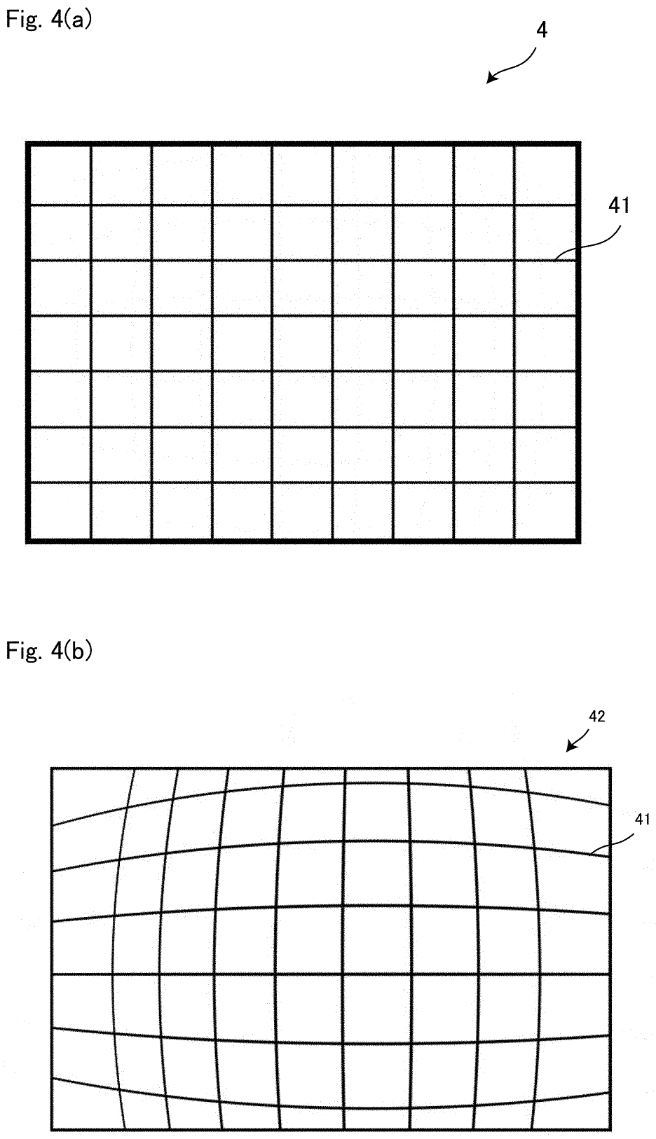

The drive recorder 2 can be prepared by using the vehicle 1. Otherwise, a drive recorder same as the drive recorder 2 may be prepared. Then, the arrangement of the first scale plate 4 can be performed in an arbitrary place. As shown in FIG. 4(a), a first scale 41 having predetermined intervals of square grids are formed on the first scale plate 4.

Next, a first scale plate image 42 shown in FIG. 4(b) is obtained by photographing the first scale plate 4 with the drive recorder 2 (S13).

The first scale plate image 42 is the image photographed by the drive recorder 2 having the distortion characteristic. Therefore, the first scale plate image 42 is displayed with the distortion, and the intervals of square grids become uneven, as shown in FIG. 4(b). However, the intervals of the square grids can be considered uniform when calculation is performed.

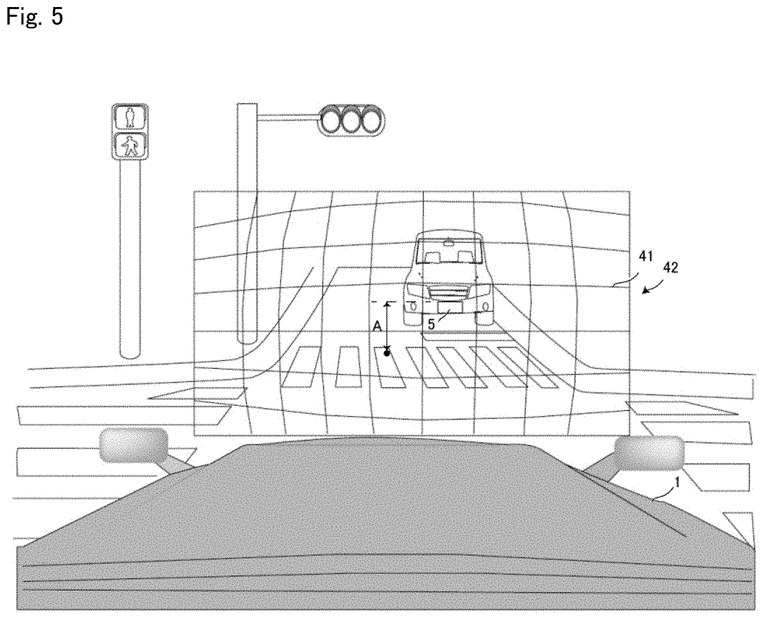

Next, as shown in FIG. 5, the first scale plate image 42 and object images 3 are overlapped with each other (S14).

In this embodiment, the data of the first scale plate image 42 and the data of the object image 3 are overlapped with each other. However, the first scale plate image 42 and the object image 3 which are printed on paper or sheet like material may be overlapped. In this case, either the first scale 41 or the object image 3 needs to be permeable, in order for both of the first scale 41 and the object image 3 to be recognized at the same time.

Next, an image-height A, which is the distance between a license plate 5 of the oncoming vehicle 10 appeared on the object image 3 (the upper end of the license plate 5 in this embodiment) and the center of the object image 3, is measured, by using the first scale 41 of the first scale plate image 42 (S15).

In particular, by counting the number of the first scale 41, which is corresponding to the vertical distance between the upper end of the license plate 5 and the center of the object image 3, the image-height A, which is the distance between a license plate 5 and the center of the object image 3, is measured.

The interval of the first scale 41 can be considered uniform, even though the first scale 41 appears to be distorted. Accordingly, the distortion of the image-height A, which is measure in S15, is corrected. In FIG. 5, considering the visibility of the figure, the object image 3 appears not be distorted. However, the object image 3 is distorted in reality, similar to the first scale plate image 42. Further in FIG. 5, considering the visibility of the figure, the first scale 41 has fewer scales. In reality, however, it is preferable that the first scale 41 is much finer scales.

Next, an angle B between a horizontal plane and a straight line which is joining the drive recorder 2 to the license plate 5 is calculated, based on the image-height A and the first distance X (S16).

As is explained by using FIG. 3, for example, the angle B can be calculated by the formula; sin B=A/√(A2+X2).

Finally, a target distances Y1 or a horizontal distance Y2, which is the distance between the drive recorder 2 and the license plate 5, is calculated, based on a height difference H, which is the distance between the preset height H2 of the drive recorder 2 and the preset height H1 of the license plate 5, and the angle B (S17).

In particular, the target distance Y1 can be calculated by the formula; sin B=H/Y1, while the horizontal distance Y2 can be calculated by the formula; tan B=H/Y2.

In the two of object image 3, which are respectively photographed at predetermined interval T, the relative velocity between the vehicle 1 (drive recorder 2) and the oncoming vehicle 10 (license plate 5), can be calculated as follows; Those steps from S13 to S17 are also conducted with respect to other object images 3, then, the difference between target distance Y1 or horizontal distance Y2, which is calculated from two object images 3, are divided by the predetermined time T.

As described above, in the position-information specifying method according to this embodiment, the image-height A of the object (license plate 5) whose distortion is corrected, is obtained by using the first scale plate image 42 corresponding to the distortion characteristic. The distortion-corrected angle B between a horizontal plane and a straight line, which is joining the drive recorder 2 to the object (license plate 5), is calculated by using the distortion-corrected image-height A and the first distance. Therefore, distortion-corrected value of the target distance Y1 or the horizontal distance between the drive recorder 2 and the object (license plate 5) can be accurately calculated, based on the height difference H between the preset height H2 of the drive recorder 2 and the preset height H1 of the immovable thing (license plate 5) and the distortion-corrected angle B as well.

In addition, the instantaneous relative velocity between the drive recorder 2 the object(license plate 5) can also be accurately calculated by dividing the difference between the two target distances Y1 or the vertical distances Y2, which are obtained from the two object images 3 by the predetermined time span which is a shot span.

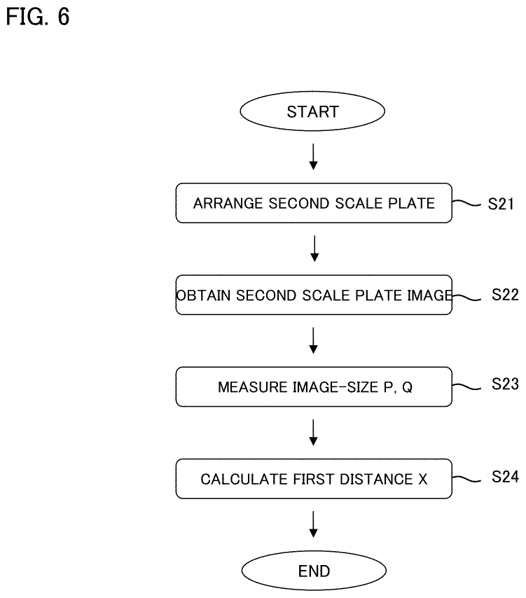

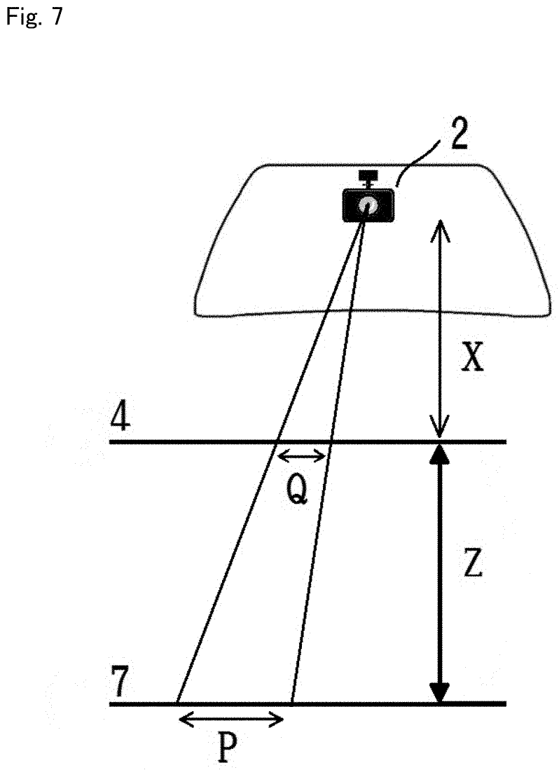

Next, a position-information specifying method according to a second embodiment of the present invention is explained, while referring to FIG. 6 to FIG. 8.

When the drive recorder 2 mounted in the vehicle and the like is used to specify the position-information, it is difficult to arrange the first scale plate 4 exactly at the first distance X apart from the drive recorder 2, since the windshield would be a hindrance.

Then, in this embodiment, considering the possibility that the first scale plate 4 cannot be arranged properly at the designated place, the first distance X is calculated, after the first scale plate 4 is arranged in an arbitrary position.

FIG. 6 is a flowchart of a way to calculate the first distance X, according to this embodiment. The process shown in FIG. 6 should be completed before S16 in FIG. 1.

First, a second scale plate 7 is arranged so as to be opposed to the first scale plate 4 at a second distance Z, as shown in Fig. (S21).

A second scale 71 is formed on the second scale plate 7 at the same predetermined intervals of square grids as the first scale 41 of the first scale plate 4. In this embodiment, the drive recorder 2, the first scale plate 4, and the second scale plate 7 are arranged in this order. However, the order of the first scale plate 4 and the second scale plate 7 can be switched.

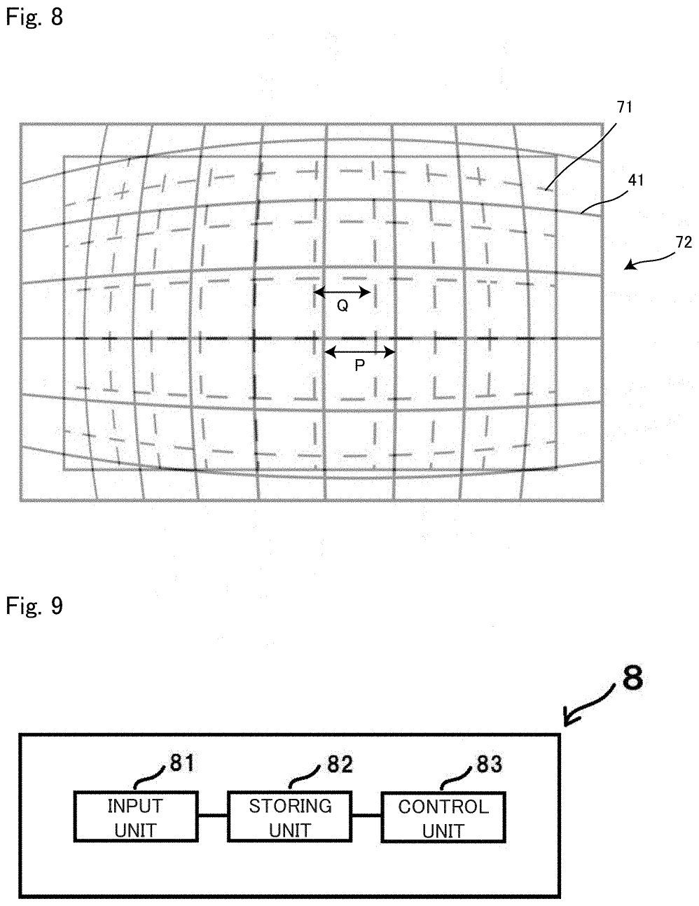

Next, a second scale plate image 72 shown in FIG. 8 is obtained by photographing the first scale plate 4 and the second scale plate 7 with the drive recorder 2 (S22).

Though the first scale 41 and the second scale 71 have the same size actually, the image of the second scale 71 is taken smaller than that of the first scale 41, as shown in FIG. 8. This is because the second scale plate 7 is placed farther away from the drive recorder 2, comparing to the first scale plate 4. Therefore, the second scale 71 is preferably made distinguishable from the first scale 41 by a dotted line or coloring, as shown in FIG. 8.

Next, an image-size P of the first scale 41 and an image-size Q of the second scale 71 of the second scale plate image 72 are measured (S23).

Finally, the first distance X is calculated based on the image-size P of the first scale 41, the image-size Q of the second scale 71 and the second distance Z (S24).

To be more specific, as in FIG. 7, the formula (X:X+Z=Q:P) is satisfied. Therefore, the first distance X is calculated by substituting, into this formula, the second distance Z which is preset, the measured image-size P of the first scale 41, and the measured image-size Q of the second scale 71.

As described above, in the position-information specifying method according to this embodiment, the first distance X is calculated after the first scale plate 4 is arranged in an arbitrary position, considering the possibility that the first scale plate 4 cannot be arranged properly at the designated place. In this way, even when the windshield would be a hindrance, the first distance X can be accurately calculated. As the result, the target distance Y1 and the horizontal distance Y2 can also be accurately calculated.

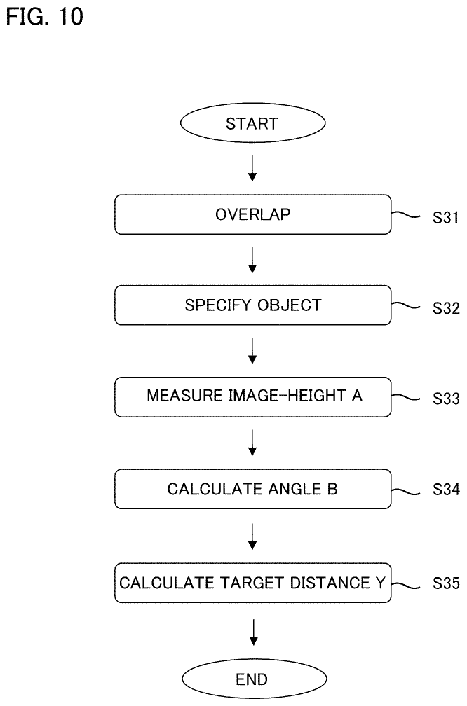

Next, a position-information specifying device 8 according to a third embodiment of the present invention is described, while referring to FIG. 9 and FIG. 10.

While the position and the velocity of the oncoming vehicle 10 are specified manually in the above embodiment, the position and the velocity of the oncoming vehicle 10 are specified by using the position-information specifying device 8 in the above embodiment. The position-information specifying device 8 may be mounted on vehicle 1, otherwise on other place than vehicle 1.

As shown in FIG. 9, the position-information specifying device 8 is provided with an input unit 81, a storing unit 82, and a control unit 83.

From the input unit 81, the first distance X, the object image 3, the first scale plate image 42 and the preset height 2 of the drive recorder 2 can be entered.

In the storing unit 82, object information (alternatives to the object, identification information for each object and, preset height H1 of the object) is stored. As for the alternatives to the object, those things are considered; license plate, vehicle, crosswalk, utility pole, traffic sign, buildings and the like. As the identifying information with respect to the object, information on the color, the shape and the size of the object can be considered to employ. As the preset height H1 of the object, a generally-set height of the license plate is stored; predetermined height H1 of crosswalk is stored like zero; the bottom of H1 is stored like zero and the top of H1 is stored like predetermined height as for vehicle, utility pole, traffic sign, and buildings.

In the storing unit 82, the first distance X, the object image 3, the first scale plate image 42, which are entered from the input unit 81, and the preset height H2 of the drive recorder 2 are also stored.

The control unit 83 calculates the target distance Y1 or horizontal distance Y2 between the drive recorder 2 and the object, based on the information stored in the storing unit 82. The control unit 83 is corresponding to the “overlapping unit”, the “specifying unit”, the “measuring unit” and the “calculating unit” of the present invention.

Hereinafter the operation of the control unit 83 is described, while the flowchart in FIG. 10 is referred. In the flowchart in FIG. 10, the operation starts, while the first distance X, the object image 3, and the first scale plate image 42 are being stored in the storing unit 82.

First, the control unit 83 overlaps the first scale plate image 42 and the object images 3, which are stored in the storing unit 82, with each other (S31).

Next, the control unit 83 specifies the object, which is appeared on the object image 3, while referring to the object information stored in the storing unit 82 (S32).

To be more specific, the control unit 83 determines the portion having little or no difference in the coloring or the shading as a single object, and then, obtains the identification information of the object such as the coloring, the shape, and the size by using the first scale plate image 42. Based on the obtained identification information, the control unit 83 specifies, as the object, which having the identification information corresponds to or approximates to the identification information stored in the storing unit 82. For example, when the obtained identification information and the identification information stored in the storing unit 82 are corresponding to each other by 90% or more, the object can be specified as the concerning object.

Next, similar to S15 of FIG. 1, the image-height A of the specified object is measured by using the first scale 41 on the first scale plate image 42 (S33). Then, similar to S16 of FIG. 1, based on the measured image-height A and the first distance X stored in the storing unit 82, the angle B is calculated (S34). Finally, similar to S17 of FIG. 1, the target distance Y1 or horizontal distance Y2 between the drive recorder 2 and the object is calculated, based on the height difference H between the preset height H2 of the drive recorder 2 and the preset height H1 of the object, and the angle B as well (S35).

Thereafter, similar to the first embodiment, the instantaneous relative velocity between the drive recorder 2 and the object can be calculated by dividing the difference of the target distances Y1 or the horizontal distances Y2 calculated with respect to each of the two target images 3, by photographing interval (predetermined time T).

As described above, the position-information specifying device 8 of this embodiment can automatically calculate the position and the velocity of the license plate 5 (the oncoming vehicle 10). It helps to save great amount of time to calculate the position and the velocity of the license plate 5 (the oncoming vehicle 10), compared to measuring the image-height A by eye.

While the position-information specifying method and the position-information specifying device of the invention has been described in detail with reference to the preferred embodiment thereof, it would be apparent to those skilled in the art that many modifications and variations may be made therein without departing from the spirit of the invention, the scope of which is defined by the attached claims.

In the above embodiments, the position and the velocity of the object (license plate 5) is specified, with respect to the position and the velocity of the first photographing means (vehicle 1), for example. However, the position and the velocity of the first photographing means may be specified with respect to the object. Such a case is also contained in the scope of the present invention.

The first photographing means, the second photographing means, and the object in the present invention are not limited to the above explained. As the first photographing means, for example, not only drive recorder 2, but security cameras installed in the street or cell phones carried by passengers may also be employed. In the similar way, as the object, not only license plate 5, various kinds of thing, such as vehicle, crosswalk, utility pole, traffic sign, buildings may also be employed.

In the above embodiments, same type of drive recorder 2 is employed in the first photographing means and the second photographing means as well. However, other type of photographing means may also be employed. In this case, it is preferable that the distortion characteristic of the first photographing means and the second photographing means are perfectly identical. However, the distortion characteristics may not be perfectly identical. For example, if both the first photographing means and the second photographing means are provided with fish-eye type of lends, the effect of the present invention can be secured. Such a case is also contained in the scope of the present invention.

In the above embodiment, the square grids of the first scale 41 and the square grids of the second scale 71 are provided on the first scale plate 4 and the second scale plate 7 respectively. However, the scale does not necessary form square grids and any mark may be employed, as long as it serves as a mark for measurement. Further, the first scale 41 and the second scale 71 are not necessary equal in size or in type of mark, as long as each of their distance can be recognized.

In the above embodiments, as shown in FIG. 1, the first scale plate 4 is arranged in S12, thereafter the image of the first scale plate 4 is photographed in S13. However, this invention also includes the case that an object corresponding to an image obtained by photographing the first scale plate 4, which is arranged so as to be opposed to the drive recorder 2 at the first distance X, is prepared in advance to be employed as the first scale plate image 42.

The present invention is also applied to a program that conducts the process of the control unit 83, or to a record media accommodating the content of the program. In the case of record media, the program should be installed on the computer. The record media storing the program may be reusable and not one-time use only. As reusable record media, for example, CD-ROM may be employed, but the record media is not limited to this.

### DESCRIPTION OF THE REFERENCE NUMBER

1 vehicle

2 drive recorder

3 object image

4 first scale plate

5 license plate

7 second scale plate

8 position-information specifying device

10 oncoming vehicle

81 input unit

82 storing unit

83 control unit

1. A location information identifying method comprising:
a step for obtaining an object image photographed by a first photographing means having a predetermined distortion characteristic, a predetermined distortion being caused on the object image due to the predetermined distortion characteristic;
a step for obtaining a first scale plate image corresponding to an image obtained when a first scale plate, which has a first scale and is arranged so as to be opposed to a second photographing means having the predetermined distortion characteristic at a first distance, is photographed by the second photographing means;
a step for overlapping the first scale plate image and the object image with each other;
a step for measuring an image-height between an object, which is appeared on the object image and located at a preset height, and a center of the object image, by using the first scale of the first scale plate image;
a step for calculating an angle between a horizontal plane and a straight line joining the first photographing means to the object, based on the image-height and the first distance; and
a step for calculating at least one of a target distance and a horizontal distance between the first photographing means and the object, based on the angle and a height difference between the first photographing means and the object.

2. The location information identifying method according to claim 1, further comprises a step for calculating two target distances or two horizontal distances between the first photographing means and the object, with respect to two object images photographed at a predetermined time span; and also calculating a relative velocity between the first photographing means and the object by dividing a difference between the two first target distances or the two horizontal distance, by the predetermined time span.

3. The location information identifying method according to claim 1, further comprising:
a step for arranging a second scale plate having a second scale so as to be opposed to the first scale plate at a second distance apart from the first scale plate;
a step for obtaining a second scale plate image which is obtained when the first scale plate and the second scale plate are photographed by the second photographing means; and
a step for calculating the first distance, based on the first scale on the second scale plate image, the second scale on the second scale plate image, and the second distance.

4. A location information identifying device comprising:
an obtaining unit configured to obtain an object image photographed by a first photographing means having a predetermined distortion characteristic, a predetermined distortion being caused on the object image due to the predetermined distortion characteristic;
a storing unit configured to store a first scale plate image corresponding to an image obtained when a first scale plate, which has a first scale and is arranged so as to be opposed to a second photographing means having the predetermined distortion characteristic at a first distance, is photographed by the second photographing means, and object information of an object which should be located at a preset height;
an overlapping unit configured to overlap the first scale plate image and the object image with each other;
a specifying unit configured to specify the object appeared on the object image while referring to the object information;
a measuring unit configured to measure an image-height between the object, which is appeared on the object image and located at the preset height, and a center of the object image, by using the first scale of the first scale plate image; and
a calculating unit configured to calculate an angle between a horizontal plane and a straight line joining the first photographing means to the object, based on the image-height and the first distance; and calculate at least one of a target distance and a horizontal distance between the first photographing means and the object, based on the angle and a height difference between the first photographing means and the object.

5. The location information identifying device according to claim 4, wherein the calculating unit calculates two target distances or two horizontal distances between the first photographing means and the object, with respect to two object images photographed at a predetermined time span; and also calculates a relative velocity between the first photographing means and the object by dividing a difference between the two first target distances or the two horizontal distance, by the predetermined time span.

6. A location information identifying program installed on a computer storing an object image photographed by a first photographing means having a predetermined distortion characteristic, a predetermined distortion being caused on the object image due to the predetermined distortion characteristic; a first scale plate image corresponding to an image obtained when a first scale plate, which has a first scale and is arranged so as to be opposed to a second photographing means having the predetermined distortion characteristic at a first distance, is photographed by the second photographing means; and object information of an object which should be located at a preset height, the program comprising:
a step for overlapping the first scale plate image and the object image with each other;
a step for specifying the object appeared on the object image while referring to the object information;
a step for measuring an image-height between the object, which is appeared on the object image and located at the preset height, and a center of the object image, by using the first scale of the first scale plate image; and
a step for calculating the angle between a horizontal plane and a straight line joining the first photographing means to the object, based on the image-height and the first distance, and calculating at least one of a target distance and a horizontal distance between the first photographing means and the object, based on the angle and a height difference between the first photographing means and the object.

7. The program according to claim 6, wherein the calculating step also calculates two target distances or two horizontal distances between the first photographing means and the object, with respect to two object images photographed at a predetermined time span; and also calculating a relative velocity between the first photographing means and the object by dividing a difference between the two first target distances or the two horizontal distance, by the predetermined time span.

8. The location information identifying method according to claim 2, further comprising:
a step for arranging a second scale plate having a second scale so as to be opposed to the first scale plate at a second distance apart from the first scale plate;
a step for obtaining a second scale plate image which is obtained when the first scale plate and the second scale plate are photographed by the second photographing means; and
a step for calculating the first distance, based on the first scale on the second scale plate image, the second scale on the second scale plate image, and the second distance.
